(19) United States
(12) Patent Application Publication
(10) Pub. No.: US 2025/0166384 A1
(43) Pub. Date: May 22, 2025

(54) METHOD AND APPARATUS WITH STATE ESTIMATION

(71) Applicant: Samsung Electronics Co., Ltd., Suwon-si (KR)

(72) Inventors: Junchen REN, Xi’an (CN); Seungin PARK, Suwon-si (KR); Ying MIN, Xi’an (CN); Zao YAO, Xi’an (CN); Byung In YOO, Suwon-si (KR); Ju Hwan SONG, Suwon-si (KR); YunHao ZHANG, Xi’an (CN); Feng ZHU, Xi’an (CN)

(73) Assignee: Samsung Electronics Co., Ltd., Suwon-si (KR)

(21) Appl. No.: 18/939,432

(22) Filed: Nov. 6, 2024

(30) Foreign Application Priority Data
Nov. 17, 2023 (CN) 202311544282.7
Sep. 26, 2024 (KR) 10-2024-0130852

(51) Int. Cl. G06V 20/52; G06T 5/20; G06T 7/20

(52) U.S. Cl. CPC G06V 20/52; G06T 5/20; G06T 7/20; G06V 2201/07

(57) ABSTRACT

A method of estimating a state includes: predicting current state prediction data of a target object by using previous state estimation data of a previous image frame of an image sequence in which the target object is represented, the previous image frame previous to a current image frame; acquiring current target detection data of the target object for the current image frame of the image sequence; and determining current state estimation data of the target object of the current image frame by updating the current state prediction data by using the current target detection data and by using a detection reliability of the current target detection data.

### CROSS-REFERENCE TO RELATED APPLICATIONS

This application claims the benefit under 35 USC § 119(a) of Chinese Patent Application No. 202311544282.7 filed on Nov. 17, 2023, in the China National Intellectual Property Administration, and Korean Patent Application No. 10-2024-0130852 filed on Sep. 26, 2024, in the Korean Intellectual Property Office, the entire disclosures of which are incorporated herein by reference for all purposes.

### BACKGROUND

### 1. Field

The following description relates to a method and apparatus for estimating a state.

### 2. Description of Related Art

Motion states (e.g., trajectories) of dynamic objects around a vehicle need to be predicted accurately in autonomous driving technology. For example, three-dimensional (3D) multiple object tracking (MOT) may be used to predict motion state. The trajectory of a target object may be predicted by using a motion model in MOT. A Kalman filter (KF) is one type of motion model that may be used for MOT algorithms. The KF's linear motion hypothesis may have prediction errors for irregular motion. In this case, an incorrect trajectory update or identity switch (IDS) may occur. In addition, all detection targets and trajectories may be dealt as if they have the same trajectory, which may cause prediction and update processes to be distorted.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method of estimating a state performed by one or more processors includes: predicting current state prediction data of a target object by using previous state estimation data of a previous image frame of an image sequence in which the target object is represented, the previous image frame previous to a current image frame; acquiring current target detection data of the target object for the current image frame of the image sequence; and determining current state estimation data of the target object of the current image frame by updating the current state prediction data by using the current target detection data and by using a detection reliability of the current target detection data.

The current target detection data may include instantaneous velocity data of the target object.

The method may further include: determining an amount of measurement noise based on the detection reliability; and determining a Kalman gain by using the measurement noise, and wherein the determining the current state estimation data includes: updating the current state prediction data by using the current target detection data and the Kalman gain based on the detection reliability.

The detection reliability may be correlated inversely to the measurement noise.

The method may further include: determining current prediction noise based on matching states, each matching state including an indication of the current state prediction data matches the current target detection data, during a predetermined interval.

The determining the current state estimation data may include: updating the current state prediction data by using the detection reliability of the current target detection data, the current prediction noise, and the current target detection data when the current state prediction data matches the current target detection data.

The determining the current prediction noise may include: determining the current prediction noise based on a mismatch score scoring mismatch between the state prediction data and the target detection data during the predetermined interval.

The determining the current state estimation data may include: determining the current state prediction data as the current state estimation data without the updating of the current state prediction data when the current state prediction data mismatches the current target detection data.

The method of claim 1 may further include: performing the predicting of the current state prediction data and the determining of the current state estimation data, based on a Kalman filter algorithm.

In another general aspect, a method of estimating a state of a target object represented in an image sequence is performed by one or more processors and the method includes: predicting current state prediction data of the target object by using previous state estimation data of a previous image frame of the image sequence; acquiring current target detection data of the target object for a current image frame of the image sequence; determining a current prediction noise for an interval of the image sequence based on a matching state between the current state prediction data and the current target detection data; and determining current state estimation data of the target object of the current image frame by updating the current state prediction data by using the current target detection data and the current prediction noise when the current state prediction data matches the current target detection data.

The current image may be changed to different images in the interval of the image sequence, the current state prediction data and the current target detection data may be predicted and acquired, respectively, for each of the different images, and the current prediction noise may be determined based on matching states between each of the current state prediction data and its corresponding current target detection data.

The determining the current state estimation data may include: updating the current state prediction data by using the detection reliability of the current target detection data, the current prediction noise, and the current target detection data when the current state prediction data matches the current target detection data.

The method may further include: determining a measurement noise based on the detection reliability; and determining a Kalman gain by using the measurement noise, and the determining the current state estimation data may include: updating the current state prediction data by using the current target detection data and the Kalman gain based on the detection reliability.

The current prediction noise may be determined based on a mismatch score between the state prediction data and the target detection data during the interval.

The determining the current state estimation data may include: determining the current state prediction data as the current state estimation data without the updating of the current state prediction data when the current state prediction data mismatches the current target detection data.

The predicting of the current state prediction data and the determining of the current state estimation data may be performed based on a Kalman filter algorithm.

A non-transitory computer-readable storage medium may store instructions that, when executed by a processor, cause the processor to perform any of the methods.

In another general aspect, an electronic device includes: one or more processors; and a memory storing instructions configured to cause the one or more processors to: predict current state prediction data of a target object by using previous state estimation data of a previous image frame of an image sequence, acquire current target detection data of the target object of a current image frame of the image sequence, determine a current prediction noise for an interval of the image sequence based on a matching state between the current state prediction data and the current target detection data, and determine current state estimation data of the target object of the current image frame by updating the current state prediction data by using the detection reliability of the current target detection data, the current prediction noise, and the current target detection data when the current state prediction data matches the current target detection data.

The current target detection data may include instantaneous velocity data of the target object, the current image may be changed to different images in the interval of the image sequence, the current state prediction data and the current target detection data may be predicted and acquired, respectively, for each of the different images, and the current prediction noise may be determined based on matching states between each of the current state prediction data and its corresponding current target detection data.

The predicting of the current state prediction data and the determining of the current state estimation data may be performed based on a Kalman filter algorithm.

Other features and aspects will be apparent from the following detailed description, the drawings, and the claims.

### BRIEF DESCRIPTION OF THE DRAWINGS

FIG. 1 illustrates an example of a prediction operation for state estimation, a Kalman gain calculation operation, and an update operation, according to one or more embodiments.

FIG. 2 illustrates an example of a state estimation method based on an adaptive update operation, according to one or more embodiments.

FIG. 3 illustrates an example of a prediction operation for state estimation, a Kalman gain calculation operation, and an adaptive update operation, according to one or more embodiments.

FIG. 4 illustrates an example of a state estimation method based on adaptive prediction, according to one or more embodiments.

FIG. 5 illustrates an example of an adaptive prediction operation for state estimation, a Kalman gain calculation operation, and an update operation, according to one or more embodiments.

FIG. 6 illustrates an example of a state estimation process including an adaptive prediction operation based on a matching state, according to one or more embodiments.

FIG. 7 illustrates an example of a configuration of an electronic device, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

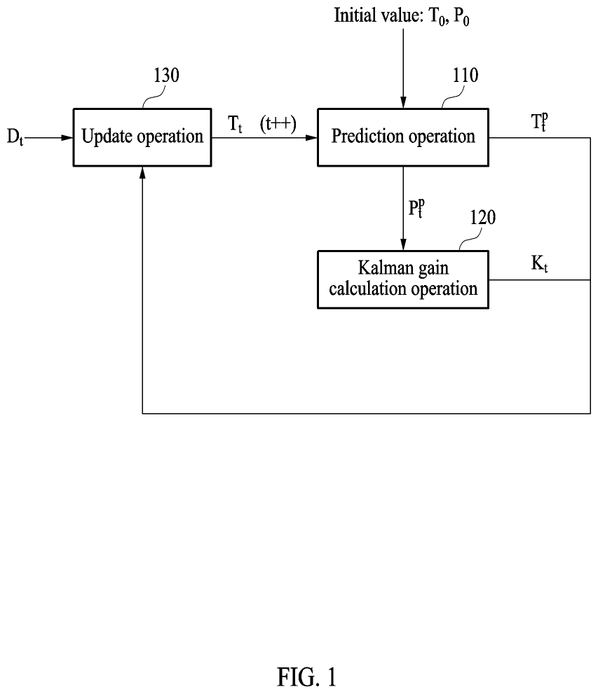

FIG. 1 illustrates an example of a prediction operation for state estimation, a Kalman gain calculation operation, and an update operation, according to one or more embodiments. State estimation data (estimated state) Tₜ of a target of an image frame at a time t may be determined based on prediction operation 110, Kalman gain calculation operation 120, and update operation 130. As time t advances and new images in an image/frame sequence arrive, state estimation for the same target in the image sequence (e.g., video) including image frames may be repeatedly performed for the new images and the same target.

For example, state prediction data (predicted state) Tₜ^{p} and prediction error covariance Pₜ^{p} may be determined/outputted by the prediction operation 110 performed for time t of the time/image sequence. The state prediction data Tₜ^{p} of time t may be predicted by using the state estimation data Tₜ₋₁ of time t−1, and the prediction error covariance Pₜ^{p} of time t may be predicted by using prediction error covariance Pₜ₋₁^{p} of time t−1. Initial state estimation data T₀ and initial prediction error covariance P₀ may be set as initial values for the initial performance of the prediction operation 110 of time t=1. Time t and image frame of time t may also be referred to as the current time and the current image frame, and time t−1 and image frame t−1 may be referred to as the previous time and the previous image frame.

A Kalman gain Kₜ of time t may be determined based on Kalman gain calculation operation 120 for time t. The Kalman gain Kₜ may be determined based on the prediction error covariance Pₜ^{p}.

The state estimation data Tₜ may be determined based on update operation 130 of time t. The update operation 130 may estimate the state estimation data Tₜ by using the state prediction data Tₜ^{p}, the Kalman gain Kₜ, and target detection data Dₜ. The target detection data Dₜ may be determined based on target detection performed on the image frame t of time t. The target detection data Dₜ may be a measured value, the state prediction data Tₜ^{p} may be a predicted value (e.g., inferred by a neural network model), and the state estimation data Tₜ may be an estimated value. The estimated value of Tₜ (estimated state) may be determined by updating the predicted value based on the measured value. The Kalman gain Kₜ may be a weight for update operation 130.

The target detection data Dₜ may be acquired by performing target detection for the current image frame of the image sequence. For example, the target detection data Dₜ may include the instantaneous velocity of the target, the position of the target, the motion direction of the target, or a combination thereof. For example, the image sequence may be based on two-dimensional (2D) or 3D image data, radio detection and ranging (RADAR) data, light detection and ranging (LiDAR) data, or a combination thereof. A bounding box of the target may be acquired based on a target detection algorithm specific to image data. The RADAR data may be used for target position acquisition and/or Doppler measurement. The LiDAR data may be used to acquire a point cloud.

According to an embodiment, the estimating of the motion state of the target may follow a tracking-by-detection (TBD) paradigm. For example, target tracking may be implemented by estimating the motion state of the target. The number of targets is not limited; description of tracking a single target is applicable to multiple targets. A 3D detector (e.g., CenterPoint, BEVFusion, a cross-modal transformer (CMT), etc.) may be used for target tracking. Preprocessing based on a selection filter (SF), non-maximum suppression (NMS), or a combination thereof may be performed for target tracking, but examples are not limited thereto. The SF may improve the inference speed of an algorithm by removing a detected obvious error effectively. The NMS may delete bounding boxes with high similarity to another bounding box to improve accuracy and suppress a loss of recall.

Prediction operation 110, Kalman gain calculation operation 120, and update operation 130 may be performed based on a Kalman filter algorithm. The target detection data Dₜ may be input data of the Kalman filter algorithm.

For a first time t=1 the state estimation data Tₜ may be initialized to the initial state estimation data T₀ and the prediction error covariance Pₜ^{p} may be initialized to the initial prediction error covariance P₀ before or with the reception of the first target detection data D₁ for first time t=1 (corresponding to a first image frame). First state prediction data T₁^{p} corresponding to the first image frame at first time t=1 may be acquired by performing prediction operation 110 based on the initial state estimation data T₀. Similarly, first prediction error covariance P₁^{p} for first time t=1 may also be acquired by the prediction operation 110 based on the initial prediction error covariance P₀. A first Kalman gain K₁ for the first time t=1 may be acquired by performing Kalman gain calculation operation 120 based on the first prediction error covariance P₁^{p}. First state estimation data T₁ (corresponding to the first image frame) may be acquired by updating the first state prediction data according to update operation 130 based on the first Kalman gain K₁ and first target detection data D₁ of the first image frame.

Second state prediction data T₂^{p} corresponding to a second image frame at second time t=2 may be acquired by performing prediction operation 110 based on the first state estimation data T₁. Second state estimation data T₂ corresponding to the second image frame may be acquired by updating the second state prediction data T₂^{p} according to update operation 130 based on a second Kalman gain K₂ and second target detection data D₂ of the second image frame. State estimation may be performed on the next image frames of the image sequence, such as a third image frame, in this manner. Gradually better state estimation may be performed by repeating the prediction operation 110, Kalman gain calculation operation 120, and update operation 130.

In the prior art, when a larger cost is set for low-reliability detection by using an appearance matching matrix and a motion cost matrix, problems from occlusion or continuous matching are not considered, and accurate state estimation may not be performed in the presence of occluded or irregular motion. In the prior art, inaccurate state estimation may be performed when irregular motion, such as sudden cornering, sudden acceleration, or sudden deceleration, across image frames occurs, since detection data is sensitive to a steady average velocity across the image frames in an update operation.

In the prior art, because pieces of detection data with different detection reliabilities are not distinguished, detection data with a low reliability impacts target matching and/or updating. In this case, state estimation accuracy may decrease, and identity switching (IDS) may occur (when a same physical object is identified as one object and then another).

In the prior art, if trajectories with different matching states are not distinguished, occlusion may cause trajectory matching failure. If a detection data-based update is not performed, state estimation accuracy may be reduced by continuous mismatches. In this case, trajectory matching based on inaccurate trajectories may cause matching errors and/or IDS.

In some embodiments, the accuracy of state estimation may be improved in response to irregular motion by reflecting instantaneous velocity onto the target detection data Dₜ. In some embodiments, low state-estimation-accuracy and/or IDS due to a low detection-reliability may be suppressed by performing update operation 130 adaptively based on detection reliability. According to an embodiment, matching errors and/or IDS due to target mismatching may be suppressed by performing prediction operation 110 adaptively based on target mismatching.

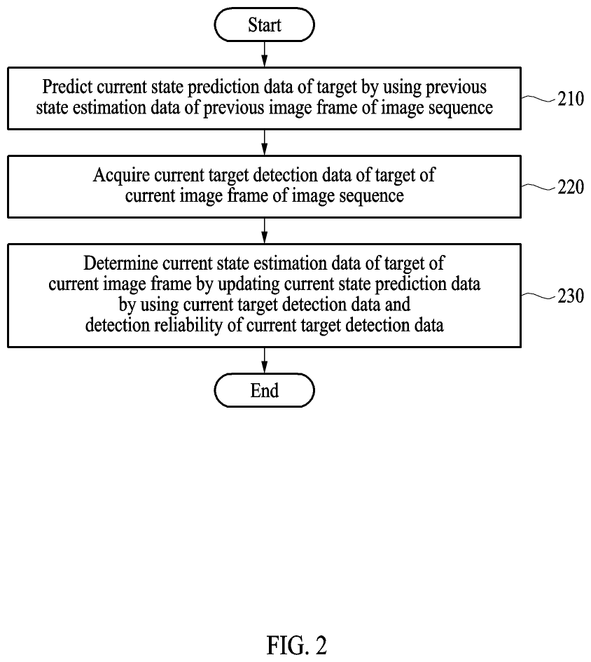

FIG. 2 illustrates an example of a state estimation method based on adaptive update, according to one or more embodiments. Referring to FIG. 2, in operation 210, an electronic device may predict current state prediction data of a target by using previous state estimation data of a previous image frame of an image sequence. It may be assumed that time t−1 is a previous time and a time t is a current time. In this case, state estimation data t−1 of image frame t−1 may be determined by updating state prediction data t−1 of the image frame t−1 based on target detection data t−1 of the image frame t−1. By using the state estimation data t−1, state prediction data t−1 may be predicted.

In operation 220, the electronic device may acquire current target detection data of the target for a current image frame of the image sequence. The current target detection data may include instantaneous velocity data of the target.

In operation 230, the electronic device may determine current state estimation data of the target of the current image frame by updating the current state prediction data by using the current target detection data and detection reliability of the current target detection data.

The electronic device may determine measurement noise based on the detection reliability. In turn, the measurement noise may be used to determine a Kalman gain. The electronic device may update the current state prediction data by using the current target detection data and the Kalman gain based on the detection reliability to determine the current state estimation data. The detection reliability may be correlated inversely to the measurement noise.

The electronic device may determine current prediction noise based on matching states, including a matching state between the current state prediction data and the current target detection data, during a predetermined intervals. For example, the predetermined interval may be a predetermined time interval or a predetermined number of frames. A matching state between state prediction data and target detection data may be determined for each image frame during an interval. The matching state may indicate whether the state prediction data matches the target detection data. For example, the matching states during an interval may indicate a mismatch score for the interval. For example, the mismatch score may include a number of mismatched frames or a ratio of mismatched frames for the corresponding interval.

The electronic device may update the current state prediction data by using the detection reliability of the current target detection data, the current prediction noise, and the current target detection data when the current state prediction data matches the current target detection data to determine the current state estimation data. The electronic device may determine the current prediction noise based on a mismatch score between the state prediction data and the target detection data during the predetermined interval. For example, the predetermined interval may be a predetermined time interval or the number of predetermined frames. The mismatch score between the state prediction data and the target detection data may be determined for each image frame during the predetermined interval. When the current state prediction data mismatches the current target detection data, the electronic device may determine the current state prediction data by directly setting it to be the current state estimation data (without the updating of the current state prediction data).

One or more of operations 210, 220, and 230 may be performed based on a Kalman filter algorithm.

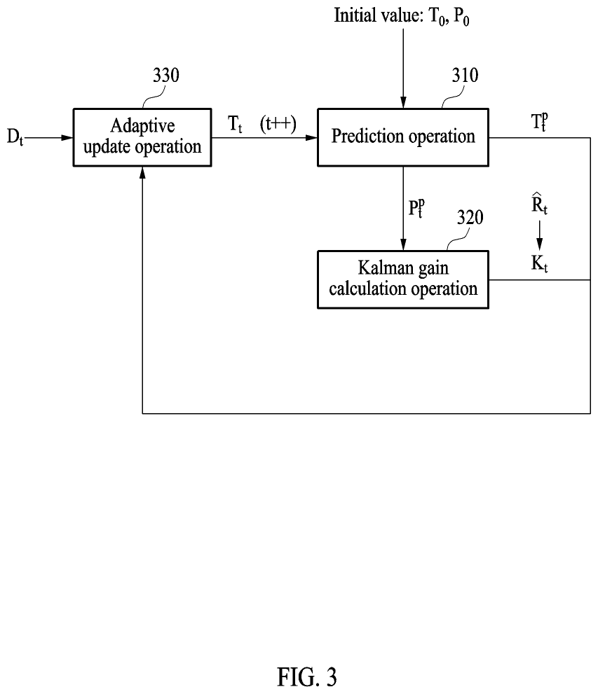

FIG. 3 illustrates an example of a prediction operation for state estimation, a Kalman gain calculation operation, and an adaptive update operation, according to one or more embodiments.

When a constant velocity (CV) model is used as a motion model, a target position of a current image frame may be determined based on Equation 1 below. The target position may be a part of state prediction data. Briefly, Equation 1 is a form of the classic formula of distance equals velocity multiplied by time; a current position is determined by adding the previous position to distance traveled.

$${p}_{t} = {p}_{t - 1} + Δ t * {v}_{t - 1} \qquad Equation 1$$

In Equation 1, pₜ denotes the target position of the current image frame of time t, pₜ₋₁ denotes a target position of a previous image frame of time t−1, vₜ₋₁ denotes the average velocity of a target motion between the current image frame and the previous image frame of time t−1, and Δt denotes a time interval between the current image frame and the previous image frame.

When a time interval between frames is great or a target moves irregularly, a difference between the average velocity and the instantaneous (e.g., inter-frame) velocity may not be ignored. When the target position or target velocity of the next image frame is predicted by using the average velocity, a prediction error may be accumulated in the next iteration, and so forth. The prediction error may be reduced by using the instantaneous velocity.

In some embodiments, target detection data Dₜ may be determined by merging the instantaneous velocity of the target with the position, size, or moving direction of the target or a combination thereof. For example, the target detection data Dₜ may be determined by performing numerical calculation, weighted calculation, or a combination thereof based on first data corresponding to the position, size, or moving direction of the target or a combination thereof and second data corresponding to the instantaneous velocity of the target. For example, the instantaneous velocity of the target may be detected by using a 3D detector. As another example, a velocity sensor may be provided to measure the instantaneous velocity of the target.

The target detection data Dₜ may be expressed in a matrix format. A measurement matrix corresponding to the target detection data Dₜ may be represented by [x y z o w l h]. x, y, and z denote 3D coordinates in the target in the current image frame. o denotes the moving direction of the target in the current image frame. width w, length l, and height h denote the size of the target (e.g., a bounding box) in the current image frame. The instantaneous velocity of the target in the current image frame is denoted by vₜ. vₜ may be represented by [vₓ v_{y} v_{z}]. The target detection data Dₜ may be determined by merging vₜ into the measurement matrix. When the target detection data Dₜ including vₜ is used, optimal velocity estimation may be performed by performing adaptive update operation 330 based on the average velocity and the instantaneous velocity. A velocity estimate may a part of state estimation data.

State estimation data Tₜ may be acquired by updating state prediction data Tₜ^{p} according to adaptive update operation 330 based on the target detection data Dₜ and a Kalman gain Kₜ. The state prediction data Tₜ^{p} of a current time t may be predicted based on state prediction data Tₜ₋₁ of a previous time t−1.

Measurement noise may be acquired based on the detection reliability of the target. The measurement noise may be inversely correlated to the detection reliability. The state estimation data Tₜ may be acquired by updating the state prediction data Tₜ^{p} based on the measurement noise and the target detection data Dₜ.

In a Kalman filter algorithm, target detection data Dₜ with a high measurement noise may have a relatively high uncertainty. In some embodiments, adaptive update operation 330 may be performed by applying a small weight to this target detection data Dₜ. The detection reliability may be used to calculate the measurement noise of the target detection data Dₜ having variable measurement noise. For example, the detection reliability may include a reliability score of the detected target. The detection reliability may be determined based on the performance of a detection model that detected the target detection data, the motion feature of the target, or a combination thereof, but examples are not limited thereto. For example, the motion feature may include motion velocity, motion direction, velocity change, direction change, or a combination thereof. The detection reliability may be set low for a great velocity change, a great direction change, or a combination thereof.

In some embodiments, the measurement noise may be determined by multiplying an inverse correlation value of the detection reliability by a tuning constant. The inverse correlation value of the detection reliability and the detection reliability may have an inverse correlation, such as inverse proportion. The inverse correlation value may be used to acquire a certainty estimate for a detection uncertainty estimate, which indicates the detection reliability. The tuning constant may be used to adjust the weight of the measurement noise. For example, the measurement noise may be represented by Equation 2 below.

$$\hat{R} = ( \frac{1}{c} ) * R \qquad Equation 2$$

\hat{R} denotes the measurement noise, c denotes the detection reliability, and R denotes the tuning constant (e.g., a constant matrix).

The detection uncertainty estimate and the target detection data Dₜ may be acquired by performing a target detection operation for an image frame t of time t. The measurement noise corresponding to the detection uncertainty estimate may be determined. Prediction error covariance Pₜ^{p} may be determined through prediction operation 310. The prediction error covariance Pₜ^{p} may be a prediction uncertainty estimate. The Kalman gain Kₜ may be determined according to Kalman gain calculation operation 320 based on measurement noise \hat{R}ₜ and the prediction error covariance Pₜ^{p}. For example, the Kalman gain Kₜ may be represented by Equation 3 below.

$${K}_{t} = {{P}_{t}^{p} ( {P}_{t}^{p} + {\hat{R}}_{t} )}^{- 1} \qquad Equation 3$$

State estimation data Tₜ may be acquired by updating the state prediction data Tₜ^{p} according to adaptive update operation 330 based on the target detection data Dₜ and the Kalman gain Kₜ. The target detection data Dₜ may include instantaneous (i.e., moment-in-time) velocity data. For example, the state estimation data Tₜ may be represented by Equation 4 below.

$${T}_{t} = {T}_{t}^{p} + {K}_{t} ( {D}_{t} - {T}_{t}^{p} ) \qquad Equation 4$$

The state estimation methods may be applied to various scenarios. For example, the state estimation methods may be used to estimate the state information, such as position, velocity, or acceleration, of the target in target tracking. For example, the state estimation method may be used for target tracking of radars, drones, or robots. The state estimation method may be used to estimate a pose of an object. For example, the state estimation method may be used for data from sensors, such as gyroscopes, accelerometers, or magnetometers, and be applied to scenarios, such as aircraft, virtual reality equipment, or robots, to realize an accurate pose estimation.

The state estimation methods may be used to estimate the position and velocity of vehicles, aircraft, or ships in navigation applications. For example, the state estimation methods may be applied to scenarios, such as global positioning system (GPS) navigation or inertial navigation. The state estimation methods may be used to predict stock prices, exchange rates, or other financial indicators in the financial field. The state estimation methods may provide accurate financial predictions by combining data from the past with real-time observations.

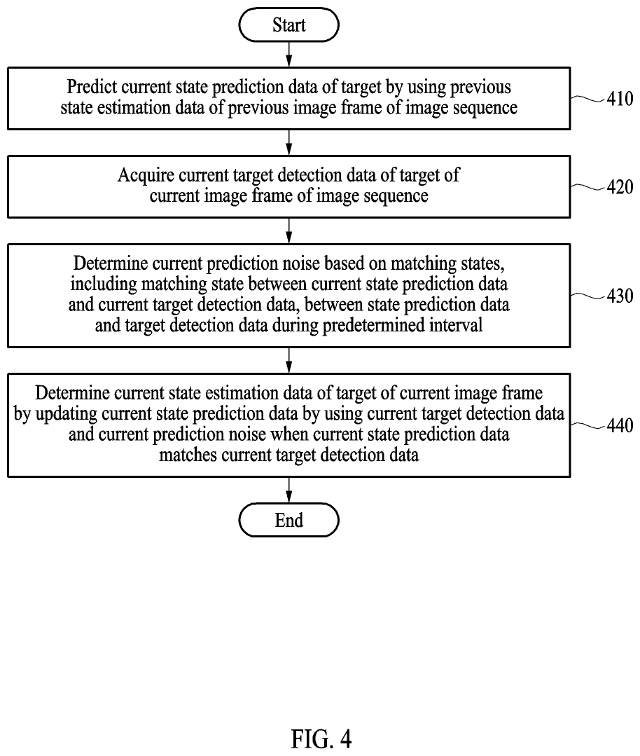

FIG. 4 illustrates an example of a state estimation method based on adaptive prediction, according to one or more embodiments. An electronic device may (i) in operation 410, predict current state prediction data of a target by using previous state estimation data of a previous image frame of an image sequence, may (ii) in operation 420, acquire current target detection data of the target of a current image frame of the image sequence, may (iii) in operation 430, determine current prediction noise based on matching states, including a matching state between the current state prediction data and the current target detection data, between state prediction data and target detection data during a predetermined interval, and may (iv) in operation 440, determine current state estimation data of the target of the current image frame by updating the current state prediction data by using the current target detection data and the current prediction noise when the current state prediction data matches the current target detection data.

The current target detection data may include instantaneous velocity data of the target.

Operation 440 may include an operation of updating the current state prediction data by using the detection reliability of the current target detection data, the current prediction noise, and the current target detection data when the current state prediction data matches the current target detection data.

The electronic device may determine measurement noise based on the detection reliability and may determine a Kalman gain by using the measurement noise. Operation 440 may include an operation of updating the current state prediction data by using the current target detection data and the Kalman gain based on the detection reliability.

Operation 430 may include an operation of determining the current prediction noise based on a mismatch score of mismatch between the state prediction data and the target detection data during the predetermined interval.

Operation 440 may include an operation of determining the current state prediction data as the current state estimation data without the updating of the current state prediction data when the current state prediction data mismatches with the current target detection data.

An operation of predicting the current state prediction data and an operation of determining the current state estimation data may be performed based on a Kalman filter algorithm.

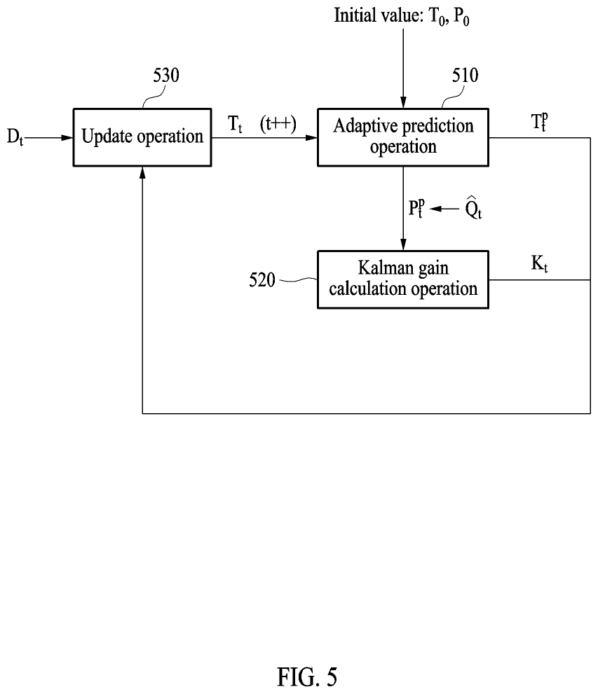

FIG. 5 illustrates an example of an adaptive prediction operation for state estimation, a Kalman gain calculation operation, and an update operation, according to an embodiment. Referring to FIG. 5, state estimation data Tₜ of a target of an image frame at a time t may be determined based on adaptive prediction operation 510, Kalman gain calculation operation 520, and update operation 530. For example, when target detection data Dₜ matches the state prediction data Tₜ^{p}, the state prediction data Tₜ^{p} may be updated by using detection reliability c of the target detection data Dₜ, prediction noise \hat{Q}ₜ, and the target detection data Dₜ. The detection reliability c and the prediction noise \hat{Q}ₜ may be reflected on a Kalman gain Kr.

When the target detection data Dₜ mismatches the state prediction data Tₜ^{p}, update operation 530 may be omitted. In this case, for adaptive prediction operation 510, the state prediction data Tₜ^{p} may be used as the state estimation data Tₜ. For example, in adaptive prediction operation 510, state prediction data Tₜ₊₁^{p}, of a next image frame may be predicted based on the state prediction data Tₜ^{p} of a current image frame. Prediction error covariance Pₜ^{p} and the prediction noise \hat{Q}ₜ may be used in adaptive prediction operation 510.

In some embodiments, trajectory information corresponding to a moving path of the target may be used for target tracking. When the target detection data Dₜ mismatches with the state prediction data Tₜ^{p}, the trajectory information of mismatched image frames may be maintained to be used for matching in a regression process.

Under the assumption that the prediction noise \hat{Q}ₜ does not change during mismatch, and the prediction noise \hat{Q}ₜ is fixed to a constant, the prediction accuracy of adaptive prediction operation 510 may decrease. An increase in a mismatch score may refer to an increase in uncertainty of a prediction environment. In this case, the prediction accuracy of adaptive prediction operation 510 may decrease.

In some embodiments, the prediction noise \hat{Q}ₜ may be determined based on a matching state between the state prediction data Tₜ^{p} and the target detection data Dₜ. The matching state may indicate whether the state prediction data Tₜ^{p} matches the target detection data Dₜ. For example, the matching state may indicate (or contribute to) a mismatch score. The mismatch score may be correlated squarely with the prediction noise \hat{Q}ₜ. For example, the mismatch score may be the number of frames having a mismatch or a ratio of frames having a mismatch. The number of mismatched frames and the mismatch ratio may be calculated based on a unit time and the preset number of frames, but examples are not limited thereto. The prediction noise \hat{Q}ₜ may be used to predict the state prediction data Tₜ^{p} of a current frame from state prediction data Tₜ₋₁^{p} of a previous frame. According to an embodiment, the prediction noise \hat{Q}ₜ may be determined based on the mismatch score between the state prediction data Tₜ^{p} and the target detection data D during a predetermined interval (e.g., a predetermined time interval or the predetermined number of frames). In other words, adaptive prediction operation 510 may be performed based on the prediction noise \hat{Q}ₜ of the current time/frame t to predict the state prediction data Tₜ₊₁^{p} of the next image frame from the state prediction data Tₜ^{p} of the current image frame.

According to an embodiment, the prediction noise \hat{Q}ₜ may be determined based on a sum of the mismatch score and the constant. The constant may be a fixed noise value or another constant for adjusting a weight. For example, measurement noise \hat{Q}ₜ may be represented by Equation 5 below.

$${\hat{Q}}_{t} = \{ \begin{matrix}Q , & if matched \\ Q + s * m * I , & if mismatched\end{matrix} \qquad Equation 5$$

In Equation 5, \hat{Q}ₜ denotes the prediction noise, Q denotes the constant (e.g., a constant matrix), s denotes the mismatch ratio, m denotes the number of mismatched frames, and I denotes a tuning constant (e.g., a constant matrix in the same dimension as that of Q).

In some embodiments, the prediction error covariance Pₜ^{p} of the current image frame may be acquired based on the prediction noise \hat{Q}ₜ of the current image frame. For example, the prediction error covariance Pₜ^{p} may be determined as shown by Equation 6.

$${P}_{t}^{p} = {P}_{t - 1}^{p} + {\hat{Q}}_{t} \qquad Equation 6$$

Here, Pₜ₋₁^{p} denotes the prediction error covariance of a previous image frame.

Referring to Equation 4, the Kalman gain Kₜ may determine whether the state estimation data Tₜ is closer to the target detection data Dₜ corresponding to a measured value or is closer to the state prediction data Tₜ^{p} corresponding to a predicted value. To estimate a better trajectory, the Kalman gain Kₜ may be adjusted adaptively according to the surrounding environment of the target of the current image frame, which is reflected in the target detection data Dₜ. The trajectory information may be a set of the state estimation data Tₜ of the target of image frames of an image sequence. Referring to Equations 3 and 6, the Kalman gain Kₜ may be calculated based on the prediction noise \hat{Q}ₜ and the measurement noise \hat{R}ₜ. Accordingly, better trajectory estimation may be performed based on the adaptively adjusted prediction noise \hat{Q}ₜ and/or measurement noise \hat{R}ₜ.

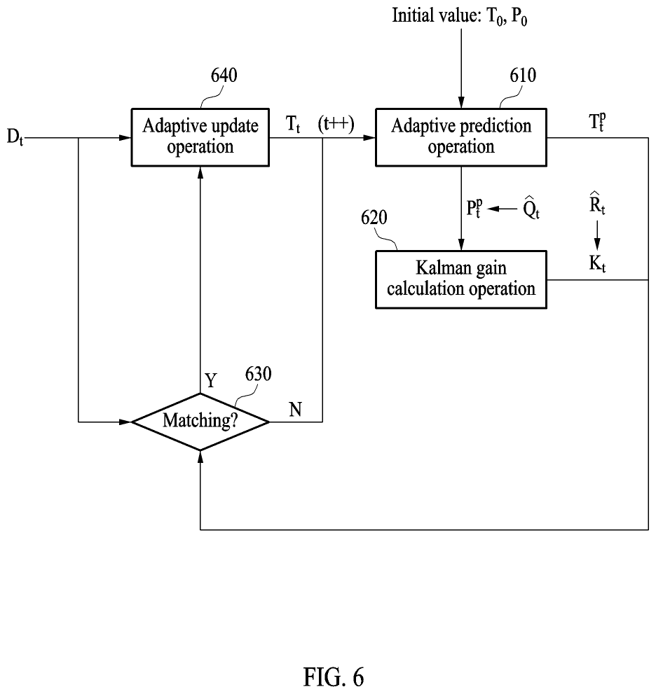

FIG. 6 illustrates an example of a state estimation process including an adaptive prediction operation based on a matching state, according to an embodiment. Referring to FIG. 6, state estimation data Tₜ of a target of an image frame at a time t may be determined based on adaptive prediction operation 610, Kalman gain calculation operation 620, and adaptive update operation 640. In operation 630, a matching state between target detection data Dₜ and state prediction data Tₜ^{p} may be determined. When the target detection data Dₜ mismatches the state prediction data Tₜ^{p}, adaptive update operation 640 may be omitted. In this case, for adaptive prediction operation 610, the state prediction data Tₜ^{p} may be used as the state estimation data Tₜ. For example, in adaptive prediction operation 610, state prediction data Tₜ₊₁^{p} of a next image frame may be predicted based on the state prediction data Tₜ^{p} of a current image frame. Prediction error covariance Pₜ^{p} and prediction noise \hat{Q}ₜ may be used in adaptive prediction operation 610.

In some embodiments, a state estimation method may be used to estimate a motion state of the target adaptively. For example, the target detection data Dₜ may be acquired by each image frame by performing 3D detection and preprocessing on an image sequence sequentially. Instantaneous velocity data of the target may be added to the target detection data Dₜ. In operation 630, a motion cost matrix Cₘₒ may be calculated between the target detection data Dₜ and the state prediction data Tₜ^{p} to determine the matching state between the target detection data Dₜ and the state prediction data Tₜ^{p}. Whether trajectory information DTₜ^{m} matched or mismatched trajectory information Dₜ^{um} or Tₜ^{um} may be determined by using the motion cost matrix Cₘₒ. Dₜ^{um} may be a measured value and Tₜ^{um} may be a predicted value. For example, when the target detection data Dₜ matches the state prediction data Tₜ^{p}, the matched trajectory information DTₜ^{m} may be generated. When the target detection data Dₜ mismatches the state prediction data Tₜ^{p}, the mismatched trajectory information Dₜ^{um} or Tₜ^{um} may be generated.

When the target detection data Dₜ matches the state prediction data Tₜ^{p}, adaptive update operation 640 may be performed by using detection reliability. The state estimation data Tₜ may be acquired by updating the state prediction data Tₜ^{p} according to adaptive update operation 640 based on the target detection data Dₜ and a Kalman gain Kₜ. For example, the state prediction data Tₜ^{p} may be updated by using detection reliability c of the target detection data Dₜ, prediction noise \hat{Q}ₜ, and the target detection data Dₜ. The detection reliability c and the prediction noise \hat{Q}ₜ may be reflected on the Kalman gain Kₜ. The state estimation data Tₜ may correspond to updated trajectory information Tₜ^{m}.

Lifespan management may be performed on the updated trajectory information Tₜ^{m} and the mismatched trajectory information Dₜ^{um} or Tₜ^{um}. For example, as many of the updated trajectory information Tₜ^{m} as the certain number of image frames and the mismatched trajectory information Dₜ^{um} or Tₜ^{um} may be retained. The state prediction data Tₜ^{p} of the current image frame may be acquired by performing adaptive prediction operation 610 based on trajectory information, for example, the updated trajectory information Tₜ₋₁^{m} corresponding to state estimation data Tₜ₋₁ of a previous image frame, which is not deleted through the lifespan management. The prediction noise \hat{Q}ₜ may be used during adaptive prediction operation 610.

In some embodiments, the matching state may be determined by obtaining a final correlation by using a matching algorithm after calculating a cost matrix between trajectory information and a detected value by using a similarity parameter when determining the matching state. For example, the trajectory information may be correlated to the detected value in a Hungarian binary matching method or generalized intersection over union (GIOU) may be selected when determining similarity. For example, the trajectory information may be a set of state information, such as the state estimation data Tₜ and the state prediction data Tₜ^{p}.

According to an embodiment, a lifespan of a trajectory and/or a state parameter may be updated based on the lifespan management. For example, a detection result may be initialized to a new trajectory T_{birth} according to the “birth” of the lifespan. A trajectory T_{die} may be removed from a management target according to “die”, and each parameter of the trajectory may be updated. For example, parameters may include the characteristics of the target, an occlusion state, and the number of mismatched frames, but examples are not limited thereto.

In some embodiments, the state estimation method may improve tracking accuracy effectively when being used as an adaptive motion module of a target tracker. The state estimation method may be applied to various detection networks and may provide further accurate information for the subsequent decisions of autonomous driving. The state estimation method may generate a trajectory by being applied to various automatic annotation systems as an algorithmic model or may be applied to scenarios, such as a detection system mounted in a vehicle, but embodiments are not limited thereto.

In some embodiments, detection reliability and/or a mismatch score may be used for state estimation, and appearance features may be unused. According to an embodiment, a measured value may be corrected through instantaneous velocity by using only a motion module. The detection reliability and/or the mismatch score may be used, and a weight of a measured value and a weight of a predicted value may be adjusted adaptively. Measurement noise may be reflected in state estimation based on the detection reliability. By doing so, a measurement weight may be adjusted through a Kalman motion model for better motion trajectory estimation.

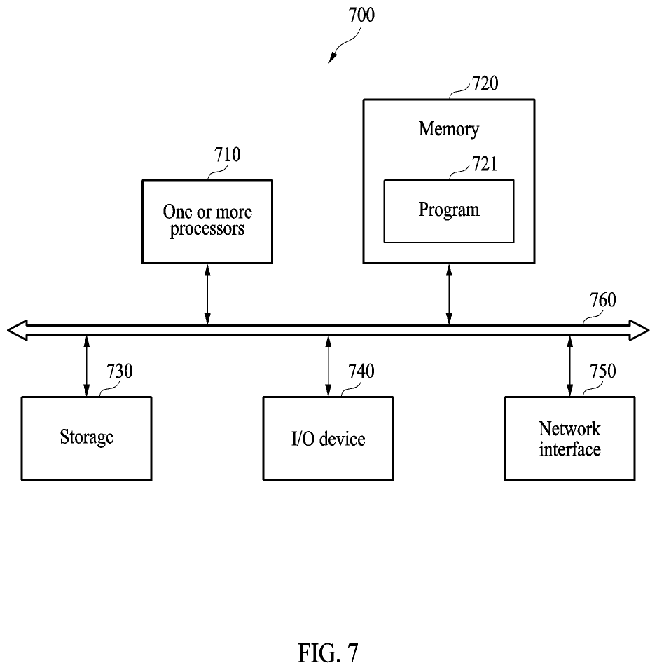

FIG. 7 illustrates an example of a configuration of an electronic device, according to one or more embodiments. Referring to FIG. 7, an electronic device 700 may include one or more processors 710, a memory 720, a storage 730, an input/output (I/O) device 740, and a network interface 750. These components may communicate with each other via a communication bus 760.

The one or more processors 710 may execute instructions stored in the memory 720 or the storage 730. When executed by the one or more processors 710, the instructions may cause the electronic device 700 to perform the operations described with reference to FIGS. 1 to 6. The memory 720 may include a non-transitory computer-readable storage medium or a non-transitory computer-readable storage device. The memory 720 may store instructions to be executed by the one or more processors 710 and may store related information while software and/or an application is being executed by the electronic device 700. The memory 720 may store a program 721 that performs state estimation in an embodiment. When at least a portion of the program 721 is stored in the memory 720, the operations described with reference to FIGS. 1 to 6 may be performed by the electronic device 700.

The storage 730 may include a computer-readable storage medium or a computer-readable storage device. The storage 730 may store a more quantity of information than the memory 720 for a long time. For example, the storage 730 may include a magnetic hard disk, an optical disc, a flash memory, a floppy disk, or other non-volatile memories known in the art.

The I/O device 740 may receive an input from the user in traditional input manners through a keyboard and a mouse, and in new input manners, such as a touch input, a voice input, and an image input. For example, the I/O device 740 may include a keyboard, a mouse, a touch screen, a microphone, or any other device that detects the input from the user and transmits the detected input to the electronic device 700. The I/O device 740 may provide an output of the electronic device 700 to the user through a visual, auditory, or haptic channel. The I/O device 740 may include, for example, a display, a touch screen, a speaker, a vibration generator, or any other device that provides the output to the user. The network interface 750 may communicate with an external device through a wired or wireless network.

The units described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, a field-programmable gate array (FPGA), a programmable logic unit (PLU), a microprocessor, or any other device capable of responding to and executing instructions in a defined manner. The processing device may run an operating system (OS) and one or more software applications that run on the OS. The processing unit also may access, store, manipulate, process, and generate data in response to execution of the software. For purpose of simplicity, the description of a processing unit is used as singular; however, one skilled in the art will appreciate that a processing unit may include multiple processing elements and multiple types of processing elements. For example, the processing unit may include a plurality of processors, or a single processor and a single controller. In addition, different processing configurations are possible, such as parallel processors.

The software may include a computer program, a piece of code, an instruction, or some combination thereof, to independently or collectively instruct or configure the processing unit to operate as desired. Software and data may be stored in any type of machine, component, physical or virtual equipment, or computer storage medium or device capable of providing instructions or data to or being interpreted by the processing unit. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs and DVDs; magneto-optical media such as optical discs; and hardware devices that are specially configured to store and perform program instructions, such as read-only memory (ROM), random-access memory (RAM), flash memory, and the like. Examples of program instructions include both machine code, such as produced by a compiler, and files containing higher-level code that may be executed by the computer using an interpreter.

The computing apparatuses, the electronic devices, the processors, the memories, the sensors, the displays, the information output system and hardware, the storage devices, and other apparatuses, devices, units, modules, and components described herein with respect to FIGS. 1-7 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-7 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A method of estimating a state performed by one or more processors, the method comprising:
predicting current state prediction data of a target object by using previous state estimation data of a previous image frame of an image sequence in which the target object is represented, the previous image frame previous to a current image frame;
acquiring current target detection data of the target object for the current image frame of the image sequence; and
determining current state estimation data of the target object of the current image frame by updating the current state prediction data by using the current target detection data and by using a detection reliability of the current target detection data.

2. The method of claim 1, wherein the current target detection data comprises instantaneous velocity data of the target object.

3. The method of claim 1, further comprising:
determining an amount of measurement noise based on the detection reliability; and
determining a Kalman gain by using the measurement noise, and
wherein the determining the current state estimation data comprises:
updating the current state prediction data by using the current target detection data and the Kalman gain based on the detection reliability.

4. The method of claim 3, wherein the detection reliability is correlated inversely to the measurement noise.

5. The method of claim 1, further comprising:
determining current prediction noise based on matching states, each matching state comprising an indication of the current state prediction data matches the current target detection data, during a predetermined interval.

6. The method of claim 5, wherein the determining the current state estimation data comprises:
updating the current state prediction data by using the detection reliability of the current target detection data, the current prediction noise, and the current target detection data when the current state prediction data matches the current target detection data.

7. The method of claim 5, wherein the determining the current prediction noise comprises:
determining the current prediction noise based on a mismatch score scoring mismatch between the state prediction data and the target detection data during the predetermined interval.

8. The method of claim 5, wherein the determining the current state estimation data comprises:
determining the current state prediction data as the current state estimation data without the updating of the current state prediction data when the current state prediction data mismatches the current target detection data.

9. The method of claim 1, further comprising:
performing the predicting of the current state prediction data and the determining of the current state estimation data, based on a Kalman filter algorithm.

10. A method of estimating a state of a target object represented in an image sequence, the method performed by one or more processors and comprising:
predicting current state prediction data of the target object by using previous state estimation data of a previous image frame of the image sequence;
acquiring current target detection data of the target object for a current image frame of the image sequence;
determining a current prediction noise for an interval of the image sequence based on a matching state between the current state prediction data and the current target detection data; and
determining current state estimation data of the target object of the current image frame by updating the current state prediction data by using the current target detection data and the current prediction noise when the current state prediction data matches the current target detection data.

11. The method of claim 10, the current image is changed to different images in the interval of the image sequence, wherein the current state prediction data and the current target detection data are predicted and acquired, respectively, for each of the different images, and wherein the current prediction noise is determined based on matching states between each of the current state prediction data and its corresponding current target detection data.

12. The method of claim 10, wherein the determining the current state estimation data comprises:
updating the current state prediction data by using the detection reliability of the current target detection data, the current prediction noise, and the current target detection data when the current state prediction data matches the current target detection data.

13. The method of claim 12, further comprising:
determining a measurement noise based on the detection reliability; and
determining a Kalman gain by using the measurement noise, and wherein
the determining the current state estimation data comprises:
updating the current state prediction data by using the current target detection data and the Kalman gain based on the detection reliability.

14. The method of claim 10, wherein the current prediction noise is determined based on a mismatch score between the state prediction data and the target detection data during the interval.

15. The method of claim 10, wherein the determining the current state estimation data comprises:
determining the current state prediction data as the current state estimation data without the updating of the current state prediction data when the current state prediction data mismatches the current target detection data.

16. The method of claim 10, wherein the predicting of the current state prediction data and the determining of the current state estimation data are performed based on a Kalman filter algorithm.

17. A non-transitory computer-readable storage medium storing instructions that, when executed by a processor, cause the processor to perform the method of claim 10.

18. An electronic device comprising:
one or more processors; and
a memory storing instructions configured to cause the one or more processors to:
predict current state prediction data of a target object by using previous state estimation data of a previous image frame of an image sequence,
acquire current target detection data of the target object of a current image frame of the image sequence,
determine a current prediction noise for an interval of the image sequence based on a matching state between the current state prediction data and the current target detection data, and
determine current state estimation data of the target object of the current image frame by updating the current state prediction data by using the detection reliability of the current target detection data, the current prediction noise, and the current target detection data when the current state prediction data matches the current target detection data.

19. The electronic device of claim 18, wherein the current target detection data comprises instantaneous velocity data of the target object, wherein the current image is changed to different images in the interval of the image sequence, wherein the current state prediction data and the current target detection data are predicted and acquired, respectively, for each of the different images, and wherein the current prediction noise is determined based on matching states between each of the current state prediction data and its corresponding current target detection data.

20. The electronic device of claim 18, wherein the predicting of the current state prediction data and the determining of the current state estimation data are performed based on a Kalman filter algorithm.
